(19) United States
(12) Patent Application Publication
(10) Pub. No.: US 2026/0126960 A1
(43) Pub. Date: May 7, 2026

(54) INTELLIGENT MIGRATION OF CI/CD WORKFLOW SERVER PIPELINES

(71) Applicant: Harness Inc., San Franicsco, CA (US)

(72) Inventors: Hemanth Mantri, San Francisco, CA (US); Dinesh Garg, Hayward, CA (US); Tianyi Li, Waterloo (CA); Bradley Rydzewski, Dublin, OH (US); Pranav Rastogi, San Francisco, CA (US)

(73) Assignee: Harness Inc., San Francisco, CA (US)

(21) Appl. No.: 18/939,895

(22) Filed: Nov. 7, 2024

(51) Int. Cl. G06F 8/30; G06F 9/445; G06F 9/54

(52) U.S. Cl. CPC G06F 8/31; G06F 9/44526; G06F 9/544

(57) ABSTRACT

A system that captures runtime data for a pipeline execution, generates an intermediate hierarchical file that includes relationships between the captured data, and converts the intermediate file to alternative format pipeline files, such as YAML files. The present system employs dynamic instrumentation of pipeline executions, regardless of their type, to capture data during pipeline execution. This approach not only facilitates the capture of comprehensive execution data but also leverages this information to seamlessly generate equivalent pipelines on alternative continuous integration platforms.

### BACKGROUND

It is vital for companies that provide software products to keep their software up to date and running smoothly. Many companies utilize workflow server pipelines to test and move their software updates to production. With many types of pipeline applications, it is desirable to migrate a pipeline from one pipeline application to another.

Migrating pipelines from JENKINS, an open source automation server, to alternate pipeline formats is a cumbersome and manual-intensive process. Existing conversion tools are only equipped to handle declarative pipelines (e.g., those defined in YAML) from YAML to YAML file, but are not able to migrate scripted pipelines (such as those written in Groovy). To convert a pipeline from one format to another, developers are typically required to do it manually, converting each part from the original pipeline format to a corresponding part in the other pipeline format. What is needed is an improved way for converting continuous integration (CI)/continuous delivery (CD) pipelines from one format to another.

### SUMMARY

The present technology, roughly described, captures runtime data for a pipeline execution, generates an intermediate hierarchical file that includes relationships between the captured data, and converts the intermediate file to alternative format pipeline files, such as YAML files. The present system employs dynamic instrumentation of pipeline executions, regardless of their type, to capture data during pipeline execution. This approach not only facilitates the capture of comprehensive execution data but also leverages this information to seamlessly generate equivalent pipelines on alternative continuous integration platforms. Consequently, the present technology ensures a versatile and automated migration process that is both platform-agnostic and capable of handling various pipeline configurations.

The present system detects runtime execution data during the execution of a continuous integration (CI)/continuous delivery (CD) workflow server. The runtime execution data is intercepted, aggregated, and then organized into a hierarchical file, such as for example a JSON file. The JSON file is utilized as an intermediate format, and from it a YAML file can be created in a variety of alternate pipeline formats. This process is performed automatically, and is much more efficient than requiring a developer to manually convert a YAML file in one format to another.

In some instances, the present technology performs a method for intelligently and automatically migrating a pipeline data file. The method begins with intercepting, during the execution of a continuous integration pipeline having a first format, runtime data by two or more instances of trace code installed in a continuous integration (CI) workflow server. Next, a JSON file is automatically generated from the intercepted runtime data, the JSON file includes data in a hierarchical format and has parent-child relationships among all the steps. A YAML file is then automatically created from the JSON file, the YAML in a second pipeline format that differs from the first pipeline format associated with the first CI workflow server.

In some instances, the present technology includes a non-transitory computer-readable storage medium having embodied thereon a program, the program being executable by a processor to intelligently and automatically migrating a pipeline data file. The method begins with intercepting, during the execution of a continuous integration pipeline having a first format, runtime data by two or more instances of trace code installed in a continuous integration (CI) workflow server. Next, a JSON file is automatically generated from the intercepted runtime data, the JSON file including data in a hierarchical format and having parent child relationship. A YAML file is then automatically created from the JSON file, the YAML in a second pipeline format that differs from the first pipeline format associated with the first CI workflow server.

In some instances, the present technology includes a non-transitory computer readable storage medium having embodied thereon a program, the program being executable by a processor to intercept, during execution of a continuous integration pipeline having a first format, runtime data by two or more instances of trace code installed in a continuous integration (CI) workflow server, automatically generate a JSON file from the intercepted runtime data, the JSON file including data in a hierarchical format and having parent child relationships; and automatically create a YAML file from the JSON file, the YAML in a second pipeline format that differs from the first pipeline format associated with the first CI workflow server.

### BRIEF DESCRIPTION OF FIGURES

FIG. 1 is a block diagram of a system for automatically converting CI/CD workflow server pipelines.

FIG. 2 is a block diagram of a convert application located on a convert server.

FIG. 3 is a block diagram of a CI/CD workflow server.

FIG. 4 is a block diagram of a trace.

FIG. 5 illustrates a workflow for a CIC the workflow server and convert service.

FIG. 6 illustrates data flow and transformation of intercepted runtime data.

FIG. 7 illustrates a method for automatically converting CI/CD workflow server pipelines.

FIG. 8 illustrates a method for installing traces in a CI/CD workflow server.

FIG. 9 illustrates a method for detecting runtime events by installed traces.

FIG. 10 illustrates a method for transmitting captured runtime data to a convert application.

FIG. 11 illustrates a method for converting aggregated data to a possible Chaisson runtime data by a plug-in.

FIG. 12 illustrates a method for creating missing data and a JSON data set.

FIG. 13 illustrates a method for creating a desired format of a YAML file.

FIG. 14 illustrates an example of a trace file.

FIG. 15 illustrates a block diagram of a computing environment for implementing the present technology.

### DETAILED DESCRIPTION

The present technology automatically creates alternate YAML files from captured runtime data from a pipeline execution. The present system generates an intermediate hierarchical file from the runtime data that includes relationships between the captured runtime data. The alternate YAML file can then be generated from the intermediate file as an alternative format pipeline file, such as a YAML file. The present system employs dynamic instrumentation of pipeline executions, regardless of their type, to capture data during pipeline execution. This approach not only facilitates the capture of comprehensive execution data but also leverages this information to seamlessly generate equivalent pipelines on alternative continuous integration platforms. As such, the present technology ensures a versatile and automated migration process that is both platform-agnostic and capable of handling various pipeline configurations.

In some instances, the present system detects runtime execution data during the execution of a continuous integration (CI)/continuous delivery (CD) workflow server. The runtime execution data is intercepted, aggregated, and then organized into a hierarchical file, such as for example a JSON file. The JSON file is utilized as an intermediate format, and from it a YAML file can be created in a variety of alternate pipeline formats. This process is performed automatically, and is much more efficient than requiring a developer to manually convert a YAML file in one format to another.

The present system addresses a technical problem in the field of software maintenance and testing, and in particular related to converting YAML files in format into YAML files of another format. There are no solutions that migrate all times of YAML files into alternate YAML files. Rather, existing solutions only convert a single YAML type or simply require a developer to migrate the files manually.

The present system solves this problem by building an intermediate file, with data having hierarchical structure based on parent and child relationships, and generating alternate YAML files from the intermediate file. The intermediate file is generated from captured execution data for a CI pipeline execution, rather than from another YAML file. With all the information from the CI pipeline execution and the data relationships therein, the present system does not rely on certain types YAML files to build another YAML file type.

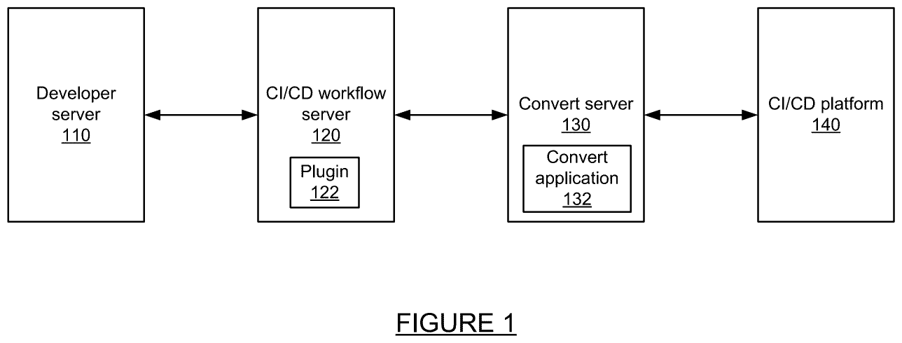

FIG. 1 is a block diagram of a system for automatically converting CI/CD workflow server pipelines. The method of FIG. 1 includes developer server 110, CI/CD workflow server 120, convert server 130, and CI/CD platform 140. Developer server 110 may include one or more physical or virtual servers from which a developer manages and works on code to update a program or network service.

CI/CD workflow server 120 may include one or more applications for building, testing, and moving code to a server. In some instance, the CI/CD workflow server may be implemented as a Jenkins application. The Jenkins application may be installed on a developer server, on a machine accessible by a developer, or some other physical or virtual machine.

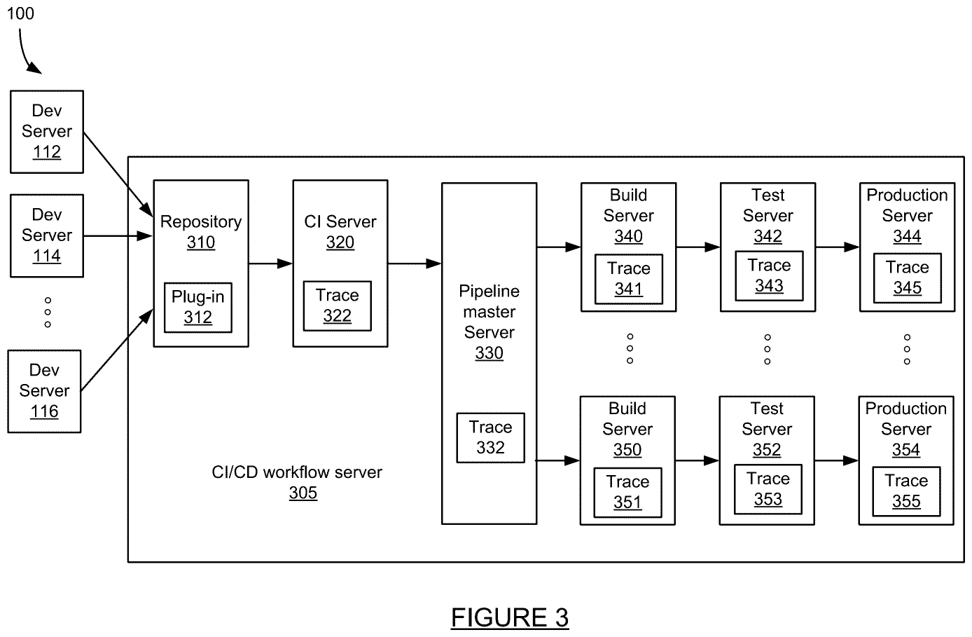

Plug-in 122 can be installed on the CI/CD workflow server 120. The plug-in can operate to oversee the conversion of a pipeline file from a format associated with the CI/CD workflow server to a secondary format. Once installed, the plug-in 122 can install trace code in various servers and modules of server 120. In some instances, the plug-in may install trace code into build servers, test servers, production servers, master servers, and other servers, code, and elements of server 120. More details for CI/CD workflow server 120 are discussed with respect to FIG. 3.

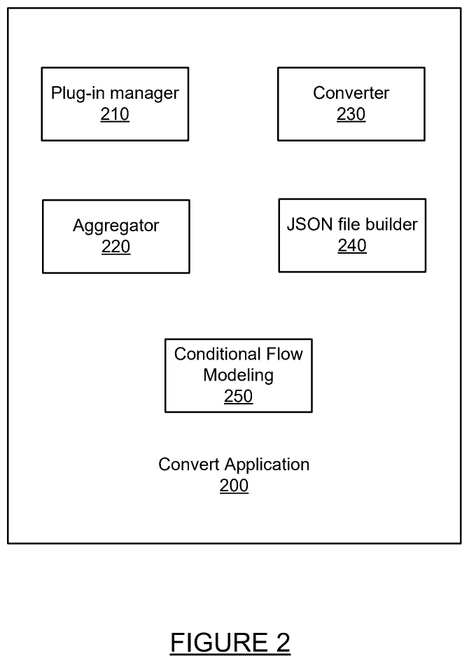

Convert server 130 may receive a JSON file and convert the JSON file to the desired YAML file. The convert server 130 may include a convert application 132 which performs the conversion between the files. The convert application may aggregate data, convert the JSON to a particular YAML file, and generate data associated with conditional flows. More details for convert application 132 are discussed with respect to FIG. 2.

CI/CD platform 140 may execute a pipeline based on the alternative pipeline file (i.e., alternative JSON file) generated from the intermediary JSON file. The second pipeline, generated from the JSON file, may be provided to CI/CD platform 140 for processing code to be considered for production. In some instances, the CI/CD platform may be provided by Harness Inc., of San Francisco, California.

FIG. 2 is a block diagram of a convert application located on a convert server. The convert application 200 includes plug-in manager 210, aggregator 220, converter 230, JSON file builder 240, and conditional flow modeling 250. Plug-in manager 210 may install the plug-into the CI/CD workflow server. The plug-in manager may determine the operating system on which the CI/CD workflow server is executing and provide the appropriate plug-in, for example in response to a user request received through the CI/CD workflow server.

In some instances, the retrieved runtime and/or execution data may be aggregated before it is used to generate a JSON file. The aggregation may occur all or in part at one or more trace modules, the plug-in on CIC workflow server 120, or at the convert application 200. When aggregated at convert application 200, aggregator 220 may aggregate the data before generating the JSON file.

Converter 230 may receive a JSON file and generate a YAML file in an alternative format. The converter 230 may receive the JSON file along with a requested format for YAML file. The converter 230 may include scripts, templates, and/or other logic to generate the desired YAML file in a format that differs from the YAML associated with the executing pipeline from which JSON was created.

JSON file builder 240 may build the JSON file from the received aggregated runtime execution data. Building the JSON file may include determining parent and child relationships between functions and nodes, and then building a hierarchical data file in JSON format. In some instances, the JSON file is built at the convert application 200. In some instances, the JSON files built by a plug-in 122 at the CI/CD workflow server.

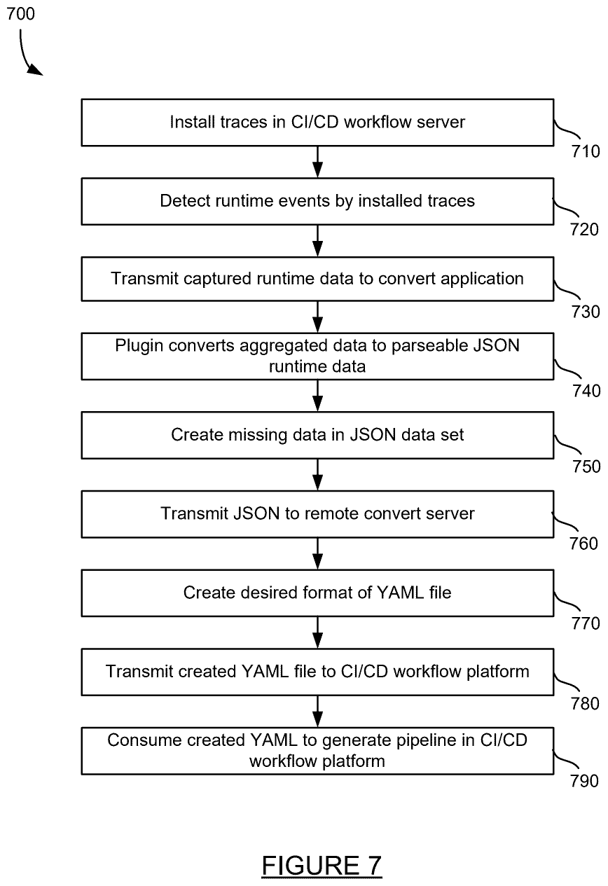

Conditional flow modeling may generate execution data for conditional scenarios during execution of the pipeline provided by the CI/CD workflow server. In some instances, certain conditions may only occasionally occur during the pipeline execution or a pipeline build within CI/CD workflow server 120. To detect and gather data on these occasional occurring scenarios, the pipeline may be monitored for an extended period of time, such as for an example one, two, or three days. In some instances, conditional flow modeling 250, rather than generate the execution data over several days, may generate the data with the use of a machine learning model. Conditional flow modeling is discussed in more detail with respect to step 750 of the method of FIG. 7.

FIG. 3 is a block diagram of a CI/CD workflow server. The CI/CD workflow server 305 includes a repository 310, a CI server 320, a pipeline master server 330, build servers 340 and 350, test servers 342 and 352, and production servers 344 and 354. When providing updated code for production, several developers may provide proposed code to the CI/CD workflow server through developer servers 112-116.

The code is received by repository 310. When code is received, it remains there until detected by CI server 320. CI server 320 may periodically perform checks to determine if new code has been received by repository 310. When new code is detected at the repository 310, the CI server 320 provides the new code to the pipeline master server 330. Server 330 then provides the code to one of several pipelines. Each pipeline may include a build server, test server, and production server.

In operation, the proposed code change is provided to build server 340, which initiates a pipeline build. After initiation, the build completes or there is an error with the build. If the build is successful, the build is tested on a test server. If the tests pass, the code is provided to a production server where the code is implemented into a product in production.

Plug-in 312 and traces 341-355 may monitor the runtime execution of the CI/CD workflow server 305. Plug-in 312 may be installed into the CI/CD workflow server from convert application 132. The plug-in 312 installs trace code, for example through instrumentation, at servers within the CI/CD workflow system such as CI server 320, pipeline master server 330, and servers 340-354. The trace code is generated by instrumenting the servers and other portions of workflow server 305. The trace code intercepts messages and data received by a transmitted from the servers or other code on which they reside.

Each of trace 322, 341, 343, 345, 351, 353 and 355 may intercept messages or data, store the data locally, optionally aggregate the data, and transmit the raw or aggregated data to plug-in 312. In some instances, the traces may intercept data and messages intended for a listener on a particular serve. The traces can then store the intercepted data, and then forward the intercepted data to the intended listener. Plug-in 312 may receive data from the traces, optionally aggregate the data, and transfer the data to a convert server. In some instances, plug-in 312 may generate a JSON file having data in a hierarchical format and transfer the JSON file to the convert server.

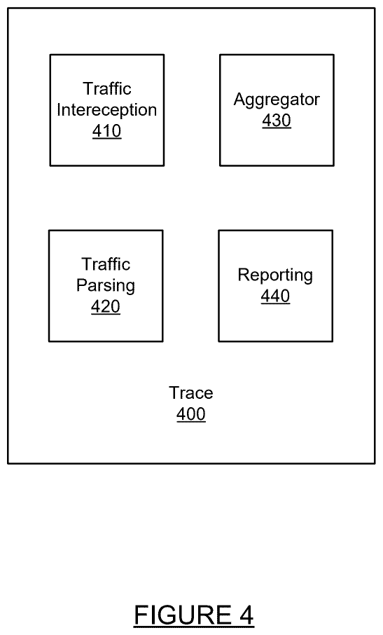

FIG. 4 is a block diagram of a trace installed via instrumentation. Trace 400 includes traffic interception 410, traffic parsing for 20, aggregator 430, and reporting 440. Traffic interception 410 may intercept incoming and outgoing traffic on whatever module, application or code that the trace is implemented on. For example, with respect to build server 340, trace 341 may intercept incoming traffic to build server 340 as well as outgoing traffic from build server 340 to test server 342 and other outgoing traffic. In some instances, traffic may be intercepted by instrumenting a listener at the particular module. As a listener receives messages or data regarding runtime events, traffic interception 410 module within a trace intercepts these messages and data, records them, and then forwards the data or message to the intended listener.

Traffic parsing 420 parses recorded traffic, including runtime execution data intercepted by traffic interception 410. The parsing of the traffic by a traffic parsing 420 can be used to determine whether or not to keep or discard intercepted data.

Aggregator 430 can aggregate intercepted and stored data. In some instances, aggregated data is used to build a JSON file. The data may be aggregated at a trace, at plug-in 312, or combination of these. Reporting 440 reports the intercepted and aggregated data collected by trace 400. The data may be reported to plug-in 312 in response to an event such as a certain time period, a request, a push, or some other event.

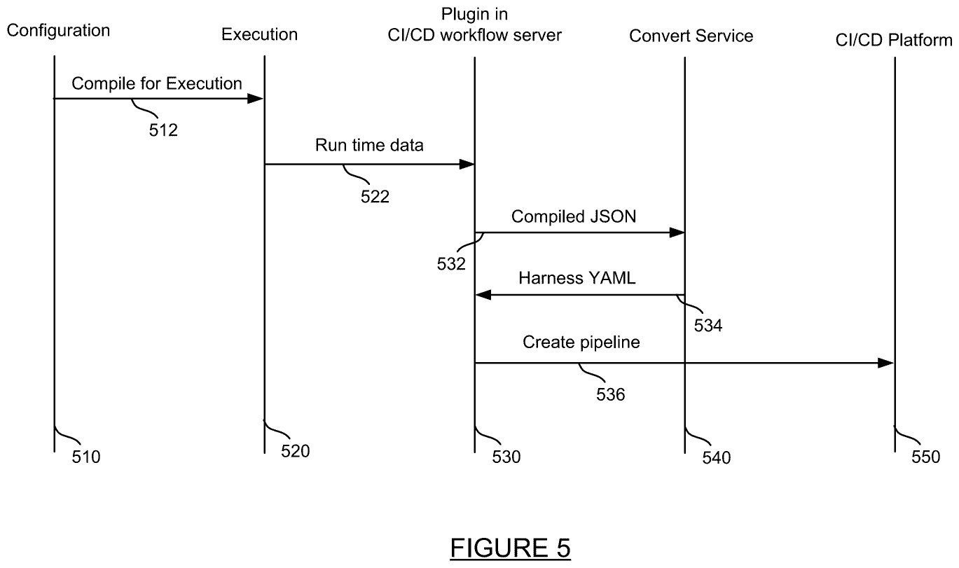

FIG. 5 illustrates a workflow for a CI/CD workflow server and convert service. The workflow of FIG. 5 begins with a configuration phase 510. At configuration, a plug-in is installed and executed in the CI/CD workflow server, such as for example a JENKINS sever. Execution of the plug-in during initialization of the CI/CD workflow server results in traces being installed by instrumentation and different servers, objects, and other code of the workflow server at runtime for the pipeline.

After configuration, a pipeline is compiled for execution at step 512 and the pipeline executes in execution phase 520. As the pipeline executes, runtime data is collected by traces at 522 and reported to plug-in 312 at the CI/CD workflow server in phase 530. A JSON file is generated or compiled from the runtime data, either by plug-in 312 or convert service 130, and the compiled JSON is accessed during the convert service phase 540. The convert service 540 then generates a selected format YAML from the JSON, and the selected format YAML is provided back to the plug-in at the CI/CD workflow server. The plug-in provides the selected format YAML to a user, and a pipeline in a separate CI/CD platform is then created at phase 550.

In previous solutions to converting one pipeline format into a pipeline format of another system, conversion of a pipeline YAML file to an alternate format of YAML was based on the first pipeline file itself. A pipeline file was manually or statically converted to a YAML pipeline file for the second system. This process is slow and tedious, and limiting as to which types of conversions can be achieved.

In the present system, a YAML file and the secondary format are not generated from another YAML file or pipeline file, but rather from execution data of a workflow server. The execution data is taken during execution of the first pipeline, and the data is converted into a hierarchical format within a JSON file. The JSON file is an intermediate file, and can be used to generate a second YAML file in the secondary format.

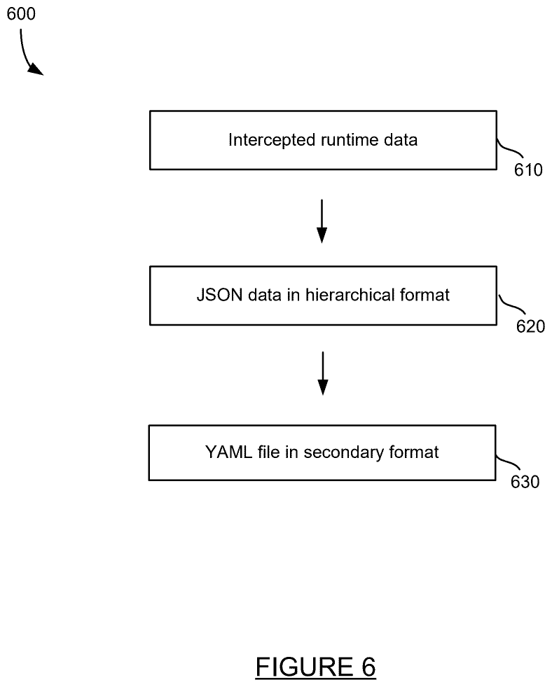

FIG. 6 illustrates data flow and transformation of intercepted runtime data. Intercepted runtime data 16 is collected by one or more trace units and then provided to a plug-in. The intercepted runtime data is then converted into JSON data 620. The JSON data is in a hierarchical format and is utilized as an intermediary file format that is not used by the first workflow server or the CI/CD platform. Rather, the JSON data file 620 created from the intercepted execution data cannot directly be used by any system. It is derived from data from a first system, and can be used to generate a pipeline in a second system that differs from the first system. The YAML file 630 is then generated based on the JSON data.

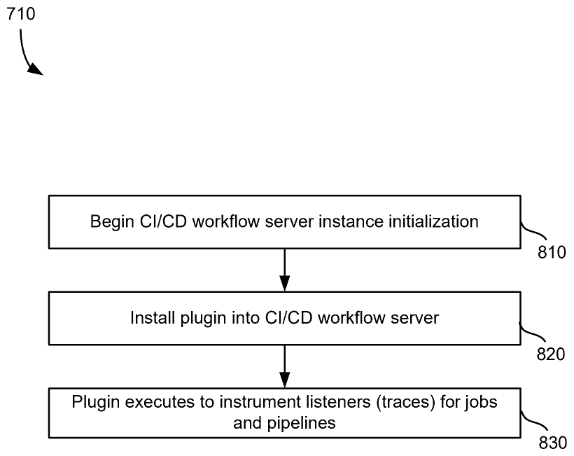

FIG. 7 illustrates a method for automatically converting CI/CD workflow server pipelines. The method of FIG. 7 begins with installing traces in a CI/CD workflow server. The traces can be installed by code within the workflow server or on a machine remote from the server. In some instances, a plug-in is installed to the CI/CD workflow server and the plug-in, when executed initialization, can install the traces. More detail for installing traces is discussed with respect to the method of FIG. 8.

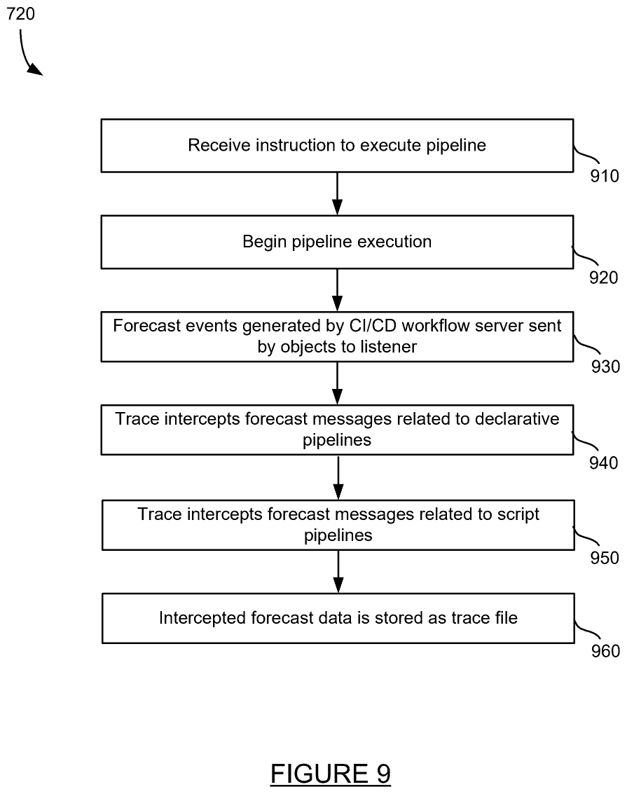

Runtime events are detected by the installed traces at step 720. The runtime events can be detected by the traces during runtime. Each trace may detect incoming traffic and data as well as outgoing traffic and data for the particular module or code that it is monitoring. More detail for detecting runtime events by installed traces is discussed with respect to the method of FIG. 9.

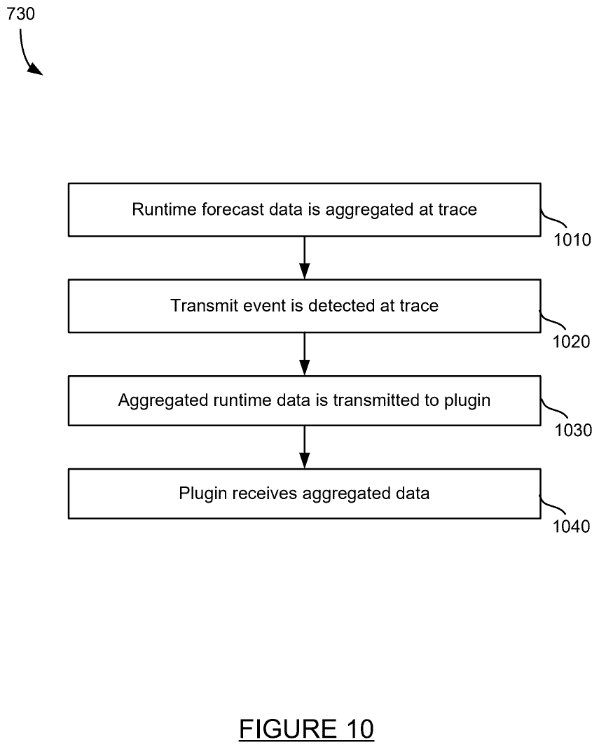

Captured runtime data is transmitted to a convert application at step 730. The captured runtime data may be aggregated and transmitted to the convert application periodically or in response to some event. More detail for transmitting captured runtime data to a convert application is discussed with respect to the method of FIG. 10.

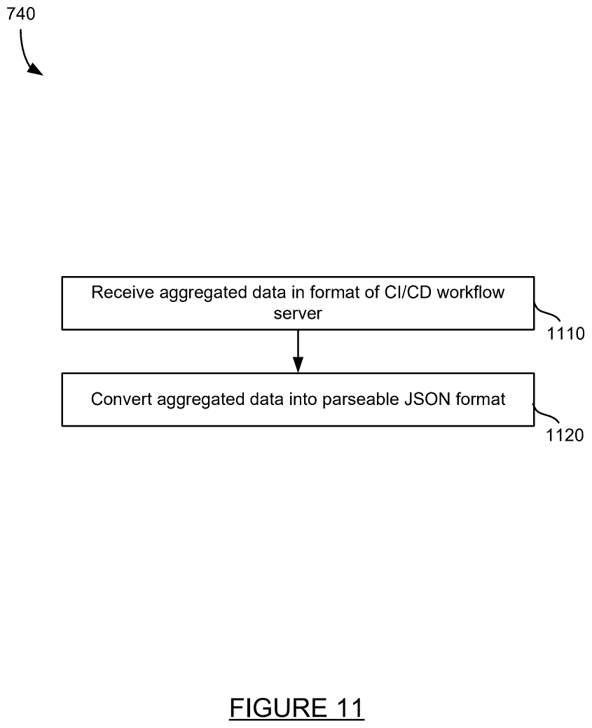

The aggregated data is converted to a JSON file at step 740. A plug-in may convert the aggregated data to the JSON file. The JSON file may include the execution data and a hierarchical format of parent nodes and child nodes. More detail for converting the aggregated data to a parcel JSON file is discussed with respect to the method of FIG. 11.

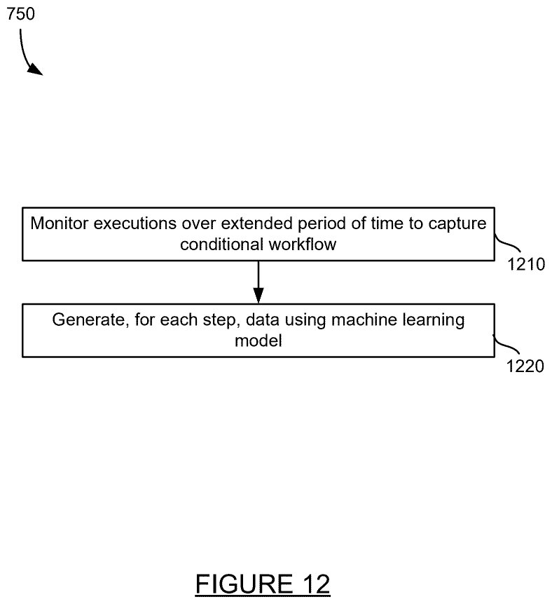

Missing data can be created in the JSON data set at step 750. In some instances, certain scenarios of execution for the pipeline may not occur for an extended period of time. In this case, the present system can create the missing data in place of intercepting it. The missing data may be created by a waiting for it to present itself over time or by generating it using a machine learning model. More information for creating missing data for a JSON data set is discussed with respect to the method of FIG. 12.

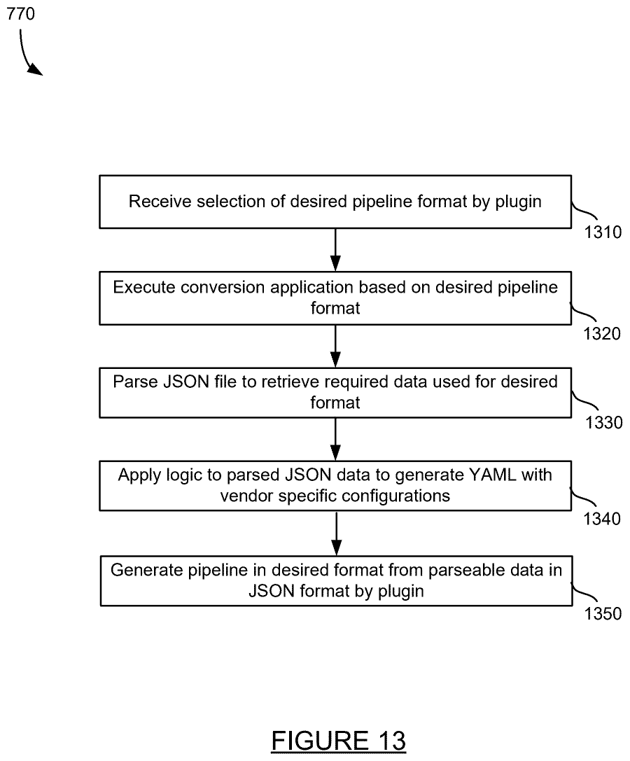

The JSON file is transmitted to a remote convert server at step 760. Along with the JSON file, an indication of what type of YAML file to convert the JSON file two is included in the transmission. A desired format of the YAML file is created at step 770. Desired format will be a different format than a YAML file or other file associated with the current pipeline being executed. Creating the desired format of YAML file is discussed in more detail with respect to the method of FIG. 13.

The created YAML file is transmitted back to the CI/CD workflow platform at step 780. The created YAML file can be transmitted directly to the CI/CD workflow platform or indirectly to the workflow platform through the plug-in. Hence, when the convert server creates the new format of YAML file, the convert server may first transmit the new YAML file to the plug-in at the CI/CD workflow server, and then that server may send the new YAML file to the workflow platform. The newly created YAML file can be consumed to generate a pipeline in the CI/CD workflow platform at step 790. As a result, the newly created YAML file is used to create a new pipeline in a different format, automatically generated from execution data associated with an original pipeline execution rather than a YAML file or other data associated with the pipeline execution.

FIG. 8 illustrates a method for installing traces in a CI/CD workflow server. The method of FIG. 8 provides more detail for step 710 of the method of FIG. 7. The CI/CD workflow server instance initialization starts at step 810. During the initialization, a plug-in is installed into the CI/CD workflow server at step 820. During runtime, the plug-in executes instrument listeners or traces for jobs and pipelines associated with the current execution at step 830.

FIG. 9 illustrates a method for detecting runtime events by installed traces. Method of FIG. 9 provides more detail for step 720 the method of FIG. 7. Instructions are received to execute a pipeline at step 910. Pipeline execution then begins at step 920. Forecast events generated by the CI/CD workflow server are sent by objects to listeners at step 930. The trace intercepts the forecast messages related to the declarative pipelines at step 940. The trace can intercept forecast messages relate to script pipelines at step 950. Traces of the present system intercept runtime data for a pipeline regardless of whether the pipeline is declarative or script. Intercepted forecast data is then stored as a trace file at step 960.

FIG. 10 illustrates a method for transmitting captured runtime data to a convert application. The method of FIG. 10 provides more detail for step 730 of the method of FIG. 7. Runtime forecast data is aggregated at a trace at step 1010. The captured runtime forecast data can be aggregated at individual trace code, by the plugin, or a combination of these two. A transmit event is detected at the trace at step 1020. The transmit event may be a periodical event or some other event, such as a push event or a pool event. Aggregated runtime data is then transmitted to the plug-in at step 1030. The plug-in receives the aggregated data at step 1040.

FIG. 11 illustrates a method for converting aggregated data to a possible JSON runtime data by a plug-in. The method of FIG. 11 provides more detail for step 740 of the method of FIG. 7. Aggregated data in the format of a CI/CD workflow server is received at step 1110. The aggregated data is then converted into a parcel JSON format at step 1120. Converting the data to a JSON format includes detecting parent and child relationships between different calls of the pipeline and organizing the data in a hierarchical parent-child structure within the JSON file.

FIG. 12 illustrates a method for creating missing data and a JSON data set. The method of FIG. 12 provides more detail for step 750 of the method of FIG. 7. Executions are monitored over an extended period of time to capture the conditional workflow at step 1210. The extended period of time may be an entire day, two days, a week, or some other period of time.

In some instances, for each step, runtime data may be generated using a machine learning model at step 1220. Machine learning model may be implemented as a generative AI system, which generates data for certain scenarios under certain conditions. In some instances, a prompt is generated from the runtime data, a description of the pipeline and format, and a request to find conditional data missing from the runtime data.

FIG. 13 illustrates a method for creating a desired format of a YAML file. The method of FIG. 13 provides more detail for step 770 the method of FIG. 7. A selection of a desired pipeline format is received by the plug-in at step 1310. A convert application is executed to generate the selected format of YAML from an intermediate JSON file at step 1320. The conversion application execution is based on the desired pipeline format. The intermediate JSON file is parsed to identify the data to include in the desired format YAML at step 1330. Logic is then applied to the parsed JSON data to generate a YAML with the vendor specific configurations at step 1340. The pipeline is then generated in a desired format from parsed data in the JSON format by the plug-in at step 1350.

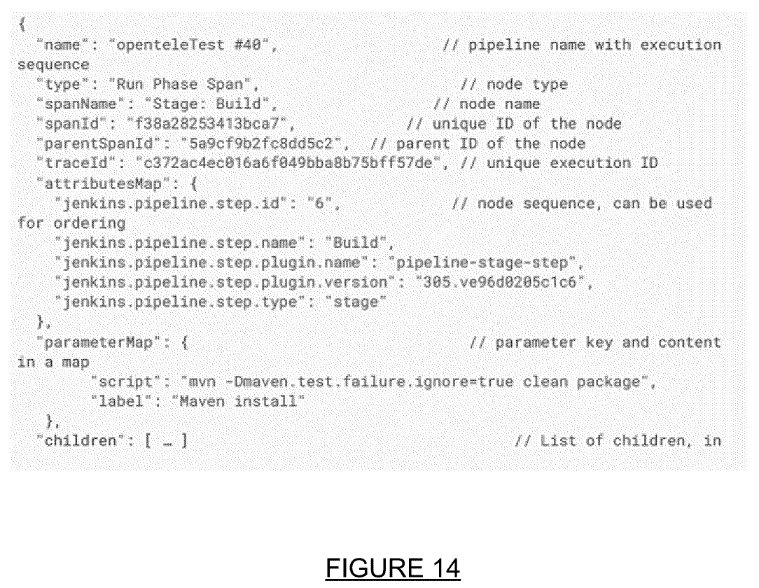

FIG. 14 illustrates an example of a trace file. The trace file FIG. 14 illustrates data in a hierarchical structure. The data was obtained by intercepting incoming messages and outgoing messages by traces installed by a plug-in.

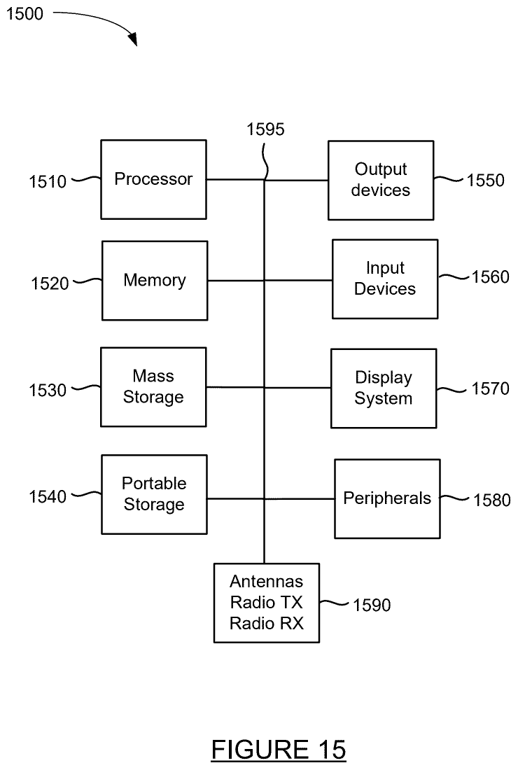

FIG. 15 is a block diagram of a computing environment for implementing the present technology. System 1500 of FIG. 15 may be implemented in the contexts of the likes of machines that implement developer server 110, CI/CD workflow server 120, convert server 130, and CI/CD platform 140. The computing system 1500 of FIG. 15 includes one or more processors 1510 and memory 1520. Main memory 1520 stores, in part, instructions and data for execution by processor 1510. Main memory 1520 can store the executable code when in operation. The system 1500 of FIG. 15 further includes a mass storage device 1530, portable storage medium drive(s) 1540, output devices 1550, user input devices 1560, a graphics display 1570, and peripheral devices 1580.

The components shown in FIG. 15 are depicted as being connected via a single bus 1595. However, the components may be connected through one or more data transport means. For example, processor unit 1510 and main memory 1520 may be connected via a local microprocessor bus, and the mass storage device 1530, peripheral device(s) 1580, portable storage device 1540, and display system 1570 may be connected via one or more input/output (I/O) buses.

Mass storage device 1530, which may be implemented with a magnetic disk drive, an optical disk drive, a flash drive, or other device, is a non-volatile storage device for storing data and instructions for use by processor unit 1510. Mass storage device 1530 can store the system software for implementing embodiments of the present invention for purposes of loading that software into main memory 1520.

Portable storage device 1540 operates in conjunction with a portable non-volatile storage medium, such as a floppy disk, compact disk or Digital video disc, USB drive, memory card or stick, or other portable or removable memory, to input and output data and code to and from the computer system 1500 of FIG. 15. The system software for implementing embodiments of the present invention may be stored on such a portable medium and input to the computer system 1500 via the portable storage device 1540.

Input devices 1560 provide a portion of a user interface. Input devices 1560 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1500 as shown in FIG. 15 includes output devices 1550. Examples of suitable output devices include speakers, printers, network interfaces, and monitors.

Display system 1570 may include a liquid crystal display (LCD) or other suitable display device. Display system 1570 receives textual and graphical information and processes the information for output to the display device. Display system 1570 may also receive input as a touch-screen.

Peripherals 1580 may include any type of computer support device to add additional functionality to the computer system. For example, peripheral device(s) 1580 may include a modem or a router, printer, and other device.

The system of 1500 may also include, in some implementations, antennas, radio transmitters and radio receivers 1590. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1500 of FIG. 15 are those typically found in computer systems that may be suitable for use with embodiments of the present invention and are intended to represent a broad category of such computer components that are well known in the art. Thus, the computer system 1500 of FIG. 15 can be a personal computer, handheld computing device, smart phone, mobile computing device, tablet computer, workstation, server, minicomputer, mainframe computer, or any other computing device. The computer can also include different bus configurations, networked platforms, multi-processor platforms, etc. The computing device can be used to implement applications, virtual machines, computing nodes, and other computing units in different network computing platforms, including but not limited to AZURE by Microsoft Corporation, Google Cloud Platform (GCP) by Google Inc., AWS by Amazon Inc., IBM Cloud by IBM Inc., and other platforms, in different containers, virtual machines, and other software. Various operating systems can be used including UNIX, LINUX, WINDOWS, MACINTOSH OS, CHROME OS, iOS, ANDROID, as well as languages including Python, PHP, Java, Ruby, . NET, C, C++, Node. JS, SQL, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for intelligently migrating a pipeline data file, comprising:
intercepting, during the execution of a continuous integration pipeline having a first format, runtime data by two or more instances of trace code installed in a continuous integration (CI) workflow server;
automatically generating a JSON file from the intercepted runtime data, the JSON file including data in a hierarchical format and having parent-child relationships; and
automatically creating a YAML file from the JSON file, the YAML in a second pipeline format that differs from the first pipeline format associated with the first CI workflow server.

2. The method of claim 1, further comprising installing a plugin into the CI workflow server, the CI workflow server having two or more servers that form the first CI pipeline.

3. The method of claim 1, further comprising instrumenting each of the two or more servers to include the two or more instances of trace code.

4. The method of claim 1, further comprising aggregating the intercepted runtime data, the JSON file generated from the aggregated runtime data.

5. The method of claim 1, wherein the YAML file is generated by a convert server remote from the CI workflow server.

6. The method of claim 1, further comprising generating runtime data related to conditions that have not occurred during pipeline execution.

7. The method of claim 1, wherein intercepting includes intercepting forecast data sent to a listener within the CI workflow server.

8. The method of claim 1, wherein the JSON file can be generated from data intercepted from either a declarative pipeline or a script pipeline.

9. The method of claim 1, wherein the CI workflow server is a Jenkins server.

10. A non-transitory computer readable storage medium having embodied thereon a program, the program being executable by a processor to perform a method for automatically and intelligently migrating a pipeline data file, the method comprising:
intercepting, during execution of a continuous integration pipeline having a first format, runtime data by two or more instances of trace code installed in a continuous integration (CI) workflow server;
generating a JSON file from the intercepted runtime data, the JSON file including data in a hierarchical format and having parent child relationships; and
creating a YAML file from the JSON file, the YAML in a second pipeline format that differs from the first pipeline format associated with the first CI workflow server.

11. The non-transitory computer readable storage medium of claim 10, further comprising installing a plugin into the CI workflow server, the CI workflow server having two of more servers that form the first CI pipeline.

12. The non-transitory computer readable storage medium of claim 10, further comprising instrumenting each of the two or more servers to include the two or more instances of trace code.

13. The non-transitory computer readable storage medium of claim 10, further comprising aggregating the intercepted runtime data, the JSON file generated from the aggregated runtime data.

14. The non-transitory computer readable storage medium of claim 10, wherein the YAML file is generated by a convert server remote from the CI workflow server.

15. The non-transitory computer readable storage medium of claim 10, further comprising generating runtime data related to conditions that have not occurred during pipeline execution.

16. The non-transitory computer readable storage medium of claim 10, wherein intercepting includes intercepting forecast data sent to a listener within the CI workflow server.

17. The non-transitory computer readable storage medium of claim 10, wherein the JSON can migrate a pipeline JSON into declarative pipelines and script pipelines.

18. The non-transitory computer readable storage medium of claim 10, wherein the CI workflow server is a Jenkins server.

19. A system for automatically and intelligently migrating a pipeline data file, comprising:
one or more servers, wherein each server includes a memory and a processor; and
one or more modules stored in the memory and executed by at least one of the one or more processors to intercept, during execution of a continuous integration pipeline having a first format, runtime data by two or more instances of trace code installed in a continuous integration (CI) workflow server, automatically generate a JSON file from the intercepted runtime data, the JSON file including data in a hierarchical format and having parent child relationships; and automatically create a YAML file from the JSON file, the YAML in a second pipeline format that differs from the first pipeline format associated with the first CI workflow server.

20. The system of claim 19, wherein the CI workflow server is a Jenkins server.
